(19) United States
(12) Patent Application Publication
(10) Pub. No.: US 2012/0182539 A1
(43) Pub. Date: Jul. 19, 2012

(54) METHOD AND APPARATUS FOR CLASSIFYING PROXIMATE MATERIALS AND ESTIMATING RANGE

(75) Inventors: Leonard H. Grokop, San Diego, CA (US); Vidya Narayanan, San Diego, CA (US)

(73) Assignee: QUALCOMM INCORPORATED, San Diego, CA (US)

(21) Appl. No.: 13/269,166

(22) Filed: Oct. 7, 2011

Related U.S. Application Data
(60) Provisional application No. 61/434,401, filed on Jan. 19, 2011.

(51) Int. Cl. G01C 3/08; G01J 3/00; G01N 21/55

(52) U.S. Cl. 356/4.01; 356/445; 356/51

(57) ABSTRACT

A mobile device may determine a material-type of a surface proximate to the device and/or a distance between the device and the proximate surface, in at least one implementation. In some implementations, proximate material-type information may be used to estimate a distance between a mobile device and a proximate surface. A material class may also be determined for a proximate surface in some implementations. Various context-based applications are disclosed for material-type, material class, and/or distance information in connection with a mobile device.

This application claims the benefit of U.S. Provisional Application No. 61/434,401, filed Jan. 19, 2011, entitled “Identifying Light Sources, Classifying Proximate Materials and Estimating Range,” which is hereby incorporated by reference in its entirety and is assigned to the assignee of the currently claimed subject matter.

### BACKGROUND

1. Field:

Subject matter disclosed herein relates generally to mobile or portable devices and, more particularly, to techniques for enhancing the usability of mobile or portable devices.

2. Information:

Context awareness refers to qualities of a mobile device that allow the device, users of the device, or a system within which the device is operating to have knowledge about an environment in which the device is operating and to react to, or change operational characteristics based upon such knowledge. Context awareness capabilities are becoming more and more prevalent in the communications industry. There is a growing need for new and useful techniques and structures for implementing context awareness in communication devices.

### SUMMARY

In at least one implementation, a mobile device may include functionality for determining a type of material that is proximate to the mobile device. The material-type may include, for example, wood, metal, plastic, skin, hair, foam, clothing, or a wide variety of other material-types. More narrowly defined material-types may also be used, for example, particular types of wood, skin of particular ethnicities, hair of different colors, and so on. In some implementations, functionality may be provided within a mobile device for estimating a distance between the mobile device and a proximate material. In at least one implementation, information on proximate material-type may be used to generate distance information. Techniques for classifying proximate material-types may also be provided. In various implementations, electromagnetic energy (e.g., light, etc.) may be emitted from a mobile device toward a proximate surface. Reflections of this energy from the proximate material may then be measured at the mobile device in a manner that captures spectral properties of the reflected energy. The captured information may then be compared to test data to determine, for example, proximate material-type and/or distance to the reflecting surface.

In one or more implementations, a machine implemented method may comprise: emitting electromagnetic energy from one or more emitters of a mobile device; and estimating a range from the mobile device to a proximate surface based, at least in part, on spectral properties of reflected energy received by one or more sensors of the mobile device, where the reflected energy includes electromagnetic energy that was emitted from the one or more emitters and reflected from the proximate surface. In other implementations, a machine implemented method may comprise: emitting electromagnetic energy from one or more emitters of a mobile device; measuring one or more spectral properties of reflected energy at the mobile device, where the reflected energy includes energy that was emitted by the one or more emitters, reflected from a surface proximate to the mobile device, and received by one or more sensors of the mobile device; and identifying a material-type of the surface proximate to the mobile device based, at least in part, on the spectral properties.

In still other implementations, a mobile device may comprise: one or more electromagnetic energy emitters; one or more electromagnetic energy sensors; and a material-type estimator to identify a material-type of a surface proximate to the mobile device based, at least in part, on spectral properties of reflected energy, where the reflected energy includes electromagnetic energy that was emitted by the one or more electromagnetic energy emitters, reflected from the surface, and sensed by the one or more electromagnetic energy sensors. In one or more other implementations, a mobile device may comprise: one or more electromagnetic energy emitters; one or more electromagnetic energy sensors; and a range estimator to estimate a distance between the mobile device and a proximate surface based, at least in part, on spectral properties of reflected energy received at the one or more electromagnetic energy sensors, where the reflected energy includes energy that was emitted by the one or more electromagnetic energy emitters and reflected by the proximate surface.

In some other implementations, an apparatus may comprise: a digital storage medium having instructions stored thereon executable by a computing system to: initiate emission of light from one or more emitters of a mobile device; measure one or more spectral properties of reflected light received at one or more sensors of the mobile device to generate measured properties, the reflected light including light that was emitted from the one or more emitters and reflected from a surface proximate to the Mobile device; and identify a material-type of the surface based, at least in part, on the measured properties. In at least one other implementation, an apparatus may comprise: a digital storage medium having instructions stored thereon executable by a computing system to: initiate emission of light from one or more emitters of a mobile device; and estimate a range from the mobile device to a proximate surface based, at least in part, on spectral properties of reflected light received at the mobile device, the reflected light including light that was emitted by the one or more emitters and reflected from the proximate surface.

In one or more implementations, an apparatus may comprise: means for emitting electromagnetic energy from a mobile device; and means for estimating a range from the mobile device to a proximate surface based, at least in part, on spectral properties of reflected energy received by one or more sensors of the mobile device, the reflected energy including electromagnetic energy that was emitted by the means for emitting electromagnetic energy and reflected from the proximate surface. In some other implementations, an apparatus may comprise: means for emitting electromagnetic energy from a mobile device; means for measuring one or more spectral properties of reflected energy at the mobile device, the reflected energy including energy that was emitted by the means for emitting electromagnetic energy, reflected from a surface proximate to the mobile device, and received by one or more sensors of the mobile device; and means for identifying a material-type of the surface proximate to the mobile device based, at least in part, on the spectral properties.

### BRIEF DESCRIPTION OF THE FIGURES

Non-limiting and non-exhaustive implementations will be described with reference to the following figures, wherein like reference numerals refer to like parts throughout the various figures unless otherwise specified.

FIG. 1 is a block diagram illustrating a mobile device that is capable of performing context awareness functions in accordance with an implementation;

FIG. 2 is a block diagram illustrating an example single sensor arrangement that may be used in a mobile device in accordance with an implementation;

FIG. 3 is a plot illustrating an example received light sensor count as a function of distance for different proximate materials in accordance with an implementation;

FIG. 4 is a plot illustrating an example frequency response of an IR sensor in accordance with an implementation;

FIGS. 5 and 6 are plots illustrating example measured reflection responses, in visible light, for human skin associated with various races in accordance with an implementation;

FIG. 7 is a flowchart illustrating an example method for capturing context-awareness related information for a mobile device in accordance with an implementation; and

FIG. 8 is a flowchart illustrating an example method for estimating a material-type of a material proximate to a mobile device, a class of the estimated material-type, or a distance to the proximate material for a mobile device in accordance with an implementation.

### DETAILED DESCRIPTION

Reference throughout this specification to “one implementation,” “an implementation,” “certain implementations,” or “various implementations” means that a particular feature, structure, or characteristic described in connection with a described implementation may be included in at least one implementation of claimed subject matter. Thus, appearances of the phrase “in one example implementation,” “in an example implementation,” “in certain example implementations,” or “in various example implementations” in various places throughout this specification are not necessarily all referring to the same implementation(s). Furthermore, particular features, structures, or characteristics may be combined in one or more implementations.

Smartphone devices may be equipped with numerous sensors in order to provide a certain base level of functionality. For example, a light sensor may be placed on the front of a device to detect a level of ambient light, so that the screen brightness can be automatically adjusted. Likewise, a proximity sensor may be placed on the front of the device to detect if, while in a call, a user is holding the device to his/her ear. These sensors, however, can provide far more functionality than originally intended. Methods and structures are described herein that use sensors to provide additional functionality within portable or mobile devices.

In some implementations, techniques may be provided for determining a type of material that is proximate to a mobile device (e.g., white paper, gray paper, skin, blonde hair, brunette hair, etc.). In other implementations, techniques may be provided for estimating a distance from a mobile device to a proximate material. As will be described in greater detail, in some implementations, these techniques may rely on the mobile device possessing either a single sensor capable of measuring reflected energy using multiple light filters with sufficiently different spectral characteristics, or multiple sensors with light filters possessing sufficiently different spectral characteristics. The material-type estimation techniques may exploit differences in spectral responses of different types of materials. A proximity detector may work by emitting a beam of energy (e.g., infra-red (IR) light) and measuring a received energy (e.g., in an infra-red band) at a neighboring sensor. As will be described in greater detail, multiple sensors with different light filtration properties may be used in some implementation to disambiguate both a proximate material-type and a distance to the proximate material. This can be done, for example, by comparing received light sensor readings and using a lookup table to identify a material-type and distance that are most consistent with the readings.

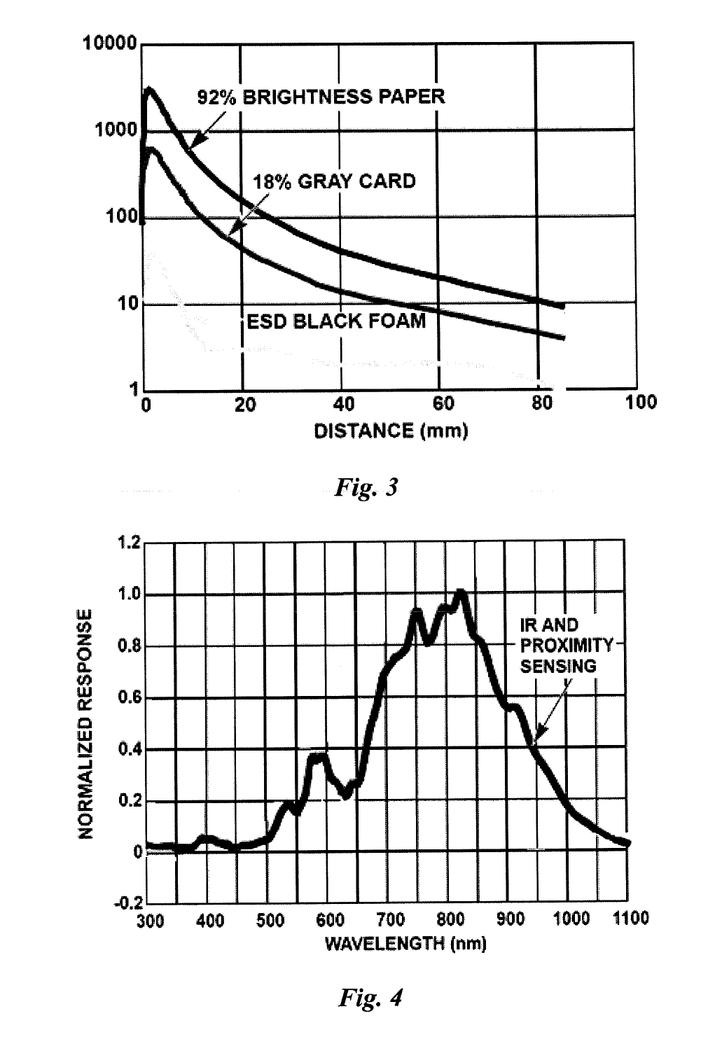

Currently available proximity sensors are unable to classify proximate materials. Consequently, they are unable to estimate a distance to a proximate material because reflected energy, and the resulting sensor readings generated thereby, may be heavily dependent on the type of material that is proximate. For example, FIG. 3 is a graph illustrating a received light sensor count as a function of distance for different proximate materials (i.e., 92% brightness paper, 18% gray card, and ESD black foam). Proximity sensors may threshold a sensor count and provide a binary decision as to whether an object is proximate. Proximity determination is therefore affected in a manner that is dependent on material-type. In other words, materials with high reflectivity may appear proximate while positioned farther away than materials with low reflectivity. Determination of proximate material-type or distance may be useful in a number of ways in a mobile device and may have particular utility in the field of context awareness. For example, in some implementations, proximate material-type may be used to determine whether a device is in a backpack, or on a desk, or next to a user's skin, or in some other location configuration. In some other example implementations, proximate material-type may be used to determine a skin color or ethnicity of a user. A distance estimate may be used, for example, to determine whether a mobile device is in a tight pants pocket or a loose shirt pocket. As will be appreciated, many other context awareness applications may also make use of proximate material-type and/or distance information.

In various implementations, a mobile device may include at least one electromagnetic energy emitter (e.g., a light emitter) and at least one electromagnetic energy sensor (e.g., a light sensor). If a “light” emitter is used, the emitter may include any type of component capable of transmitting light within a desired wavelength range (e.g., an infra-red (IR) emitter, an ultraviolet emitter, a visible light emitter, a low power laser emitter, etc.). If a light emitter is used, the at least one sensor should be capable of sensing light within the wavelength range of the emitted energy. In operation, light may be emitted by a light emitter and propagate toward a surface proximate to the mobile device (e.g., a desktop, an article of clothing, a user's skin, etc.). After reaching the proximate surface, some of the light may be reflected by the surface back toward the mobile device. The reflected light may then be detected by the at least one sensor. As will be described in greater detail, the reflected light may thereafter be processed in a manner that may determine a material-type of the proximate surface or a distance to the proximate surface. In the description that follows, some features may be described in the context of a system that utilizes IR light. It should be appreciated, however, that claimed features may also be practiced using energy in other portions of the electromagnetic spectrum including, in some implementations, non-light portions of the electromagnetic spectrum without deviating from claimed subject matter.

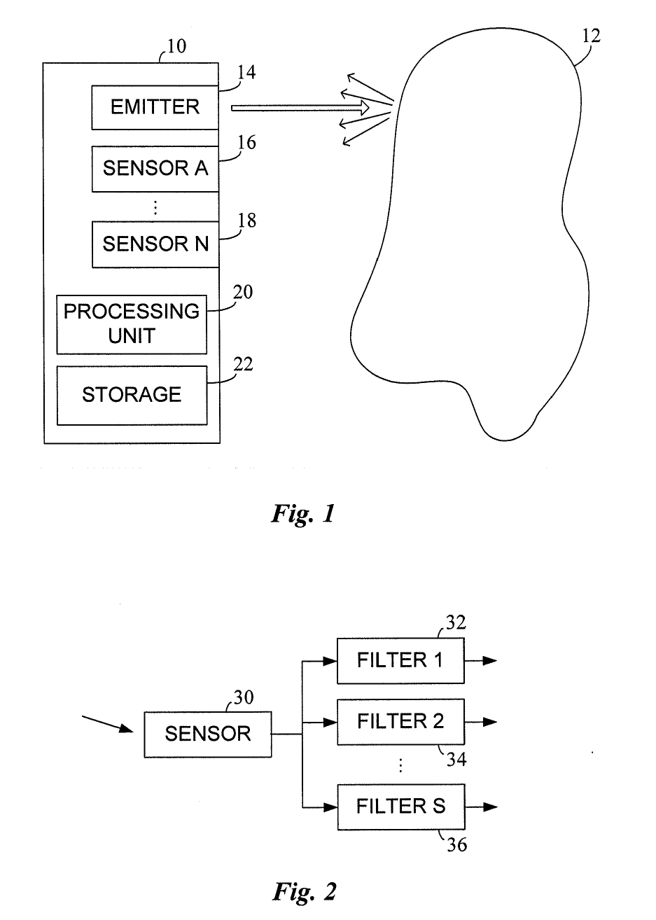

FIG. 1 is a block diagram illustrating a mobile device 10 in the vicinity of an object 12 in accordance with an implementation. As described previously, in various implementations, the mobile device 10 may include functionality for determining: (i) a material-type of a reflecting surface near the mobile device 10 (e.g., a surface of object 12) or (ii) a distance from the mobile device 10 to the reflecting surface. As shown, the mobile device 10 may include: an emitter 14; one or more sensors 16; 18; a processing unit 20; and digital storage 22. Processing unit 20 may include one or more digital processors. Digital storage 22 may include any type of device or component that is capable of storing, for example, digital data or program information for access by a processing unit. Emitter 14 may include any type of device or component for generating and emitting a beam of electromagnetic energy. In some implementations, the emitter 14 is a light emitter (e.g., an IR diode, a laser diode, a light emitting diode (LED), an ultraviolet diode, etc.). The one or more sensors 16, 18 may include any type of device that is capable of sensing energy that has been emitted from emitter 14 and reflected from a surface in proximity to mobile device 10 (e.g., a surface of object 12). Object 12 may include any type of object, structure, animal, or person that is proximate to mobile device 10 at a particular point in time.

In various implementations, digital storage 22 may have test information stored therein that is representative of a large number of measurements of reflection responses of many different types of materials located at different distances from mobile device 10. In at least one approach, this data may be arranged as a lookup table, although other data structures may alternatively be used. Example techniques for using this measurement data are discussed below.

As described above, the mobile device 10 may include one or more sensors 16, 18 for sensing reflected light. Each of the sensors 16, 18 may have a corresponding frequency response, H(f). FIG. 4 is a graph illustrating an example frequency response of an IR sensor in accordance with an implementation. In implementations that use multiple sensors, each sensor may have a different frequency response from each other sensor. If there are S sensors, then the frequency responses of the sensors may be represented as H [symbol] (f), [symbol] {1, . . . , [symbol] }, where j is the sensor index. These frequency responses may be the responses of the sensors themselves or each frequency response may correspond to a combination of a sensor and an associated filter. In implementations that use a single sensor, the single sensor may have a number of filters coupled to it to achieve different frequency responses. FIG. 2 is a block diagram illustrating an example single sensor arrangement that may be used in an implementation. As shown, a sensor 30 is coupled at an output port to a bank of S filters 32, 34, 36. Each of the filters 32, 34, 36 in the bank may have a different filter response. Thus, the overall response associated with each filter 32, 34, 36 may be a combination of the response of the sensor 30 and the response of the filter. As with the multiple sensor arrangement, this may be represented as H [symbol] (f) [symbol] ε{1, . . . , S}, where H [symbol] (f) is the combined frequency response of the sensor 30 and filter j. In some implementations, a hybrid approach may be used where a mobile device includes multiple sensors, some or all of which have multiple filters associated with them. By using sensors or sensor-filter combinations having different filter responses (or different spectral profiles), it is possible to capture spectral properties of reflected energy that can be used to, for example, determine a material-type of or distance to a proximate surface.

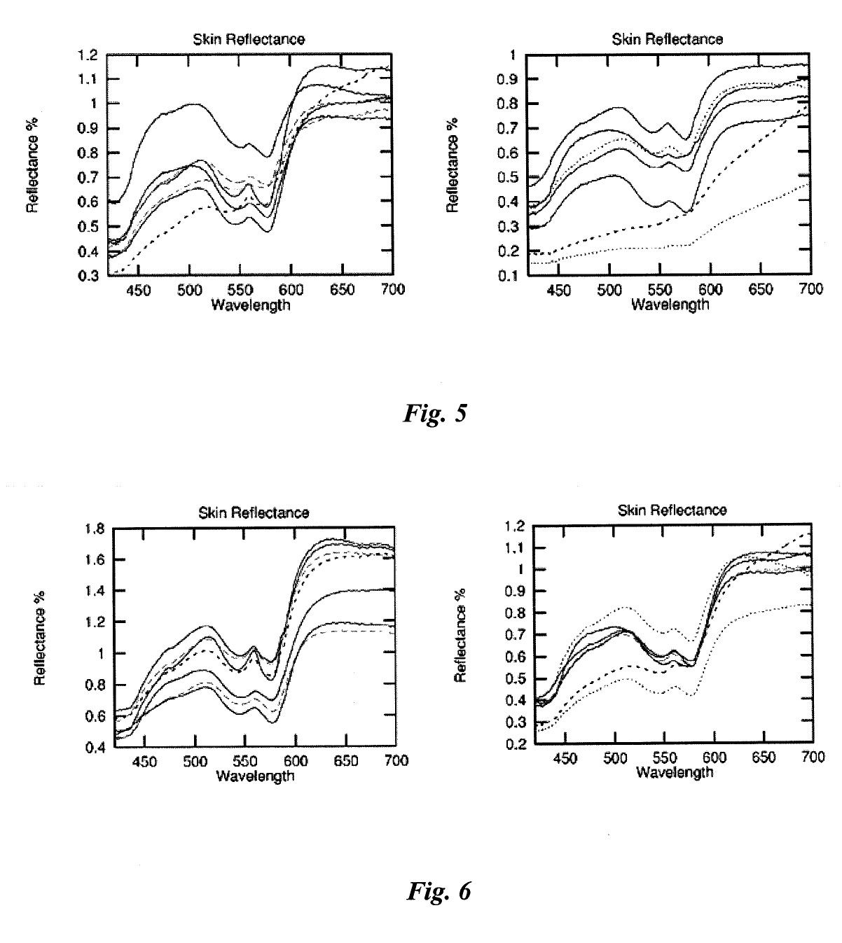

In the discussion that follows, it may be assumed that emitter 14 of FIG. 1 comprises an IR light emitter and sensors 16, 18 comprise IR light sensors in the particular illustrated implementation. However, claimed subject matter is not limited in this manner. Some or all of the below-described processing tasks may be implemented within a digital processing device (e.g., processing unit 20 of FIG. 1, etc.). For example, processing unit 20 of FIG. 1, or other similar structures, may operate as, for example, a material-type estimator, a range estimator, a material classifier, a comparison unit, and/or other functionality with appropriate programming and/or configuration. In some implementations, however, these functions may be provided by structures other than processing unit 20 or by other structures acting in association with processing unit 20. During a measurement routine, emitter 14 may emit an IR beam having a power spectral density [symbol] |Q(f)| [symbol] , where f ε[ [symbol] ], f [symbol] is a lower frequency limit of the IR energy, and fᵤ is an upper frequency limit of the IR energy. The reflection response of the surface of object 12 near mobile device 10 may be represented as Rₘ(f), where m ε{1, . . . , M} may denote a material-type of the surface of object 12 and M may denote a quantity of different materials whose reflection responses Rₘ(f) may be catalogued in a material database of test information (e.g., stored in digital storage 22 of FIG. 1). FIGS. 5 and 6 are plots illustrating example measured reflection responses, in visible light, for human skin associated with various races (Caucasian, Asian, East Indian, and African). The plots of FIG. 5 are for skin on the back of the hand of the test subjects and the plots of FIG. 6 are for skin in the center of the palm of the test subjects. Similar data may be collected for a variety of other or alternative proximate materials in various implementations.

While a reflecting surface of material-type m is present at a distance d from a mobile device, the energy received at a light sensor j of the mobile device may be represented as [symbol] . An approximate expression for this received energy is:

$$B \text{?} ( d ) = \text{?} \text{?} \vert H \text{?} \vert \text{?} d \text{?} . \\ \text{?} \text{indicates text missing or illegible when filed}$$

In some implementations, as an approximation, it may be assumed that the S light sensors of the mobile device are sufficiently close to one another so that a common range d applies to all of the light sensors. In some implementations, light sensors may be used that have some degree of directionality in their receive beams. Thus, the sensors may be described as having a corresponding receive beam pattern T(θ), where θ is the angle of incidence of light onto the light sensor. In such implementations, it may be assumed that the proximate reflecting material is roughly situated within the receive beam of the light sensor (i.e., it can be assumed that |(θ)| [symbol] ) [symbol] .

To accurately identify a proximate material and/or estimate its distance from a mobile device, one may rely on variations in the reflection frequency responses of the various reflecting materials (e.g., R [symbol] m(f)) and the frequency responses of the sensors (e.g., H [symbol] (f), or sensor-filter combinations. For example, it can be shown that an accurate identification of proximate material can be made if, for pairs of possible materials (m₁,m [symbol] )ε( [symbol] 1, . . . , M)×( [symbol] 1, . . . , M), the following condition exists:

$$rank ( \begin{matrix}\text{?} & \text{?} \\ \text{?} & \text{?} \\ \text{?} & \text{?}\end{matrix} ) \text{?} \text{?} . \\ \text{?} \text{indicates text missing or illegible when filed}$$

In at least one implementation, measurements of received energy at S sensors may be made for a set of M materials over a range of distances dε[d₁,dᵤ], where d₁ is a shortest distance and dᵤ is a longest distance. These measurement values may be arranged as vector valued functions [symbol] ₘ(d)=[ [symbol] _{m,1}(d), . . . [symbol] _{m,s}(d)]^{T} in some implementations. As described previously, FIG. 3 is a graph illustrating received energy data (e.g., received sensor count) at a single sensor for three different proximate materials (i.e., 92% brightness paper, 18% gray card, and ESD black foam). In at least one implementation, a database or lookup table (or other data structure) of measured test data may be generated and stored within a mobile device for sensors to be used in material-type estimation and range determination operations. In some implementations, this information may be stored within a mobile device during manufacture or before a unit is placed on sale. In other implementations, the information may be downloaded from a server by an end user after purchase of the mobile device. As will be appreciated, other techniques for loading measured test data into a mobile device may also be used and the claimed subject matter is not limited in this regard.

In one possible approach, a classification system may be used that divides the M different material-types into C different classes (where M>>C). The class that a material m belongs to may be denoted as yₘε{1, . . . , C}. These class assignments yₘ may be stored in a look up table or other data structure within a mobile device in some implementations. In one possible implementation, for example, proximate materials may be divided into three classes: (1) skin, (2) clothing, and (3) other. Using this approach, measurements may be made for a number of different types of skin, clothing, and other surfaces that are neither skin nor clothing. In another possible implementation, materials may be divided into classes based on skin complexion (e.g., Caucasian, Asian, Indian, and African). As will be appreciated, many alternative classification strategies may be used in other implementations.

If knowledge of a proximate material-type, proximate material class, and/or range to a proximate surface of a mobile device is desired, an emitter associated with the mobile device may emit electromagnetic energy (e.g., light) toward the surface. The electromagnetic energy may thereafter be reflected from the proximate surface and at least some of the reflected energy may propagate back toward the mobile device. This reflected energy may then be detected by one or more sensors of the mobile device. The reflected energy readings of the various sensors of the mobile device (or of a single sensor with multiple filters, etc.) may be measured and stored. These energy readings may be represented as x=[ [symbol] x [symbol] . . . x_{S}] [symbol] for S sensors (or S sensor/filter combinations). Given these energy readings, the material-type of the proximate material, the material class of the proximate material, and the distance from the mobile device to the proximate material may be estimated. As described above, in various implementations, the vector valued functions [symbol] (d), . . . [symbol] _{M}(d) and the class assignments y [symbol] . . . y [symbol] associated with the M materials may be stored within the mobile device. This information may be used, along with the energy readings x of the sensors (or sensor/filter combinations), to identify a material class or measure distance.

In one possible approach, a two stage solution technique may be used where the material-type of the proximate material is first determined and then the range is estimated. Normalized versions of the vector valued functions [symbol] [symbol] (d) . . . [symbol] _{M}(d) and the energy readings x=[ [symbol] ₁, . . . , [symbol] x_{S}] [symbol] may be calculated as follows:

$${\overline{B}}_{m} = [ 1 \frac{\text{?}}{\text{?}} , … , \frac{\text{?}}{\text{?}} ] , and$$

$$\overline{x} = [ 1 \frac{{x}_{2}}{{x}_{1}} , … , \frac{{x}_{2}}{{x}_{1}} ] \text{?} . \\ \text{?} \text{indicates text missing or illegible when filed}$$

Note that these vectors do not depend on the range d . A nearest-neighbor search may then be used to classify the proximate material by choosing the class corresponding to the nearest point (using, e.g., a Euclidean distance metric or other criterion). In one possible implementation, this may be expressed as:

[symbol]

,

where \hat{m}=arg min [symbol] _{{} [symbol] _{}}| x̅− [symbol] ₘ|² is the estimated proximate material and [symbol] is the class of the estimated proximate material. After the proximate material has been identified and/or classified, a range to the proximate material may be estimated as follows:

\hat{d}= [symbol] min [symbol] ∥x−E_{\hat{m}}(d)∥ [symbol] ^{.}

Note that the vector valued functions associated with the estimated proximate material \hat{m} and the original energy readings x (as opposed to the normalized values x̅) are used in this expression. The vector valued functions associated with the estimated proximate material \hat{m} may cover multiple different distances. The above equation may select a vector valued function associated with the estimated material-type that minimizes a selection criterion. The estimated range may then be taken as the range associated with the selected vector valued function.

The problem of estimating a proximate material-type or class and/or a distance to a proximate material using energy readings x of one or more sensors, the vector valued functions [symbol] ₁(d), . . . [symbol] [symbol] (d), and the class assignments y [symbol] , . . . , y_{M} associated with the M materials may be characterized as a classical machine learning problem. There are numerous different techniques that may be used to solve such a problem, in addition to the technique described above.

In some implementations, as described above, electromagnetic energy having a power spectral density |Q(f)| [symbol] is emitted from an emitter, reflects off of a proximate surface, and is detected by multiple sensors or sensor/filter combinations. In some other implementations, on the other hand, instead of using a single transmit signal with multiple sensors or sensor/filter combinations, a single sensor or sensor/filter combination may be used with multiple different transmit signals (e.g., S light pulses having power spectral densities |Q [symbol] (f)| [symbol] . This technique may utilize, for example, multiple different emitters or a single emitter with multiple different transmit filters. Therefore, instead of relying on variations in the reflection frequency responses of the various reflecting materials and the frequency responses of the sensors (i.e., H [symbol] (f)) or sensor/filter combinations to classify the proximate material and estimate its distance, one can rely on variations in the reflection frequency responses of the various reflecting materials and the power spectral densities of the transmit pulses. This can be done because it is not the metrics individually that are important, but the products of the metrics (e.g., | [symbol] [symbol] (f)Q(f)R [symbol] (f)| [symbol] .

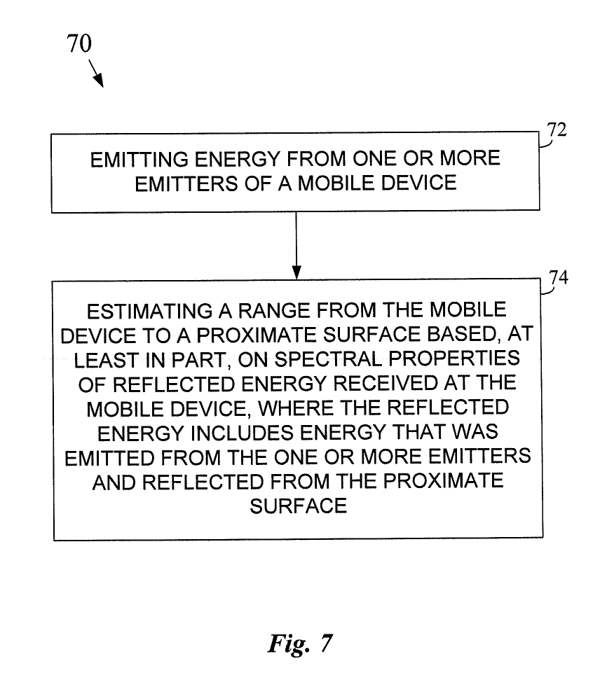

FIG. 7 is a flowchart illustrating an example method 70 for capturing context-awareness related information for a mobile device in accordance with an implementation. In some implementations, for example, some or all of the method 70 may be implemented by a digital processing device (e.g., processing unit 20 of FIG. 1 or similar structures). Energy may be emitted from one or more emitters of a mobile device (block 72). A range from the mobile device to a proximate surface may then be estimated based, at least in part, on spectral properties of reflected energy received at the mobile device (block 74). The reflected energy may include energy that was emitted by the one or more emitters and then reflected by the proximate surface back toward the mobile device. The reflected energy may be measured by one or more sensors of the mobile device. The reflected energy measurements may be compared to test information stored within the mobile device that was previously measured for a variety of different materials and distances to determine the range from the mobile device to the proximate surface. In one possible approach, a single emitter and a plurality of sensors and/or sensor/filter combinations are used. The sensors or sensor/filter combinations may each have a unique spectral filter profile that allows the sensors to garner information about the spectral properties of the reflected energy (e.g., energy levels in different spectral regions). The spectral properties of the reflected energy may be based, at least in part, on the type of material that comprises the proximate surface. In another possible approach, a number of emitters may be used, or a single emitter with a number of different transmit filters, to emit multiple pulses of electromagnetic energy having different spectral profiles. These pulses may propagate toward the proximate surface and reflect therefrom. One or more sensors may then be used to measure the reflected energy. Many alternative combinations of emitters, sensors, and/or filters may be used in various implementations. In at least one implementation, the energy emitted from the emitter is light, although non-light electromagnetic energy may also be used in other implementations.

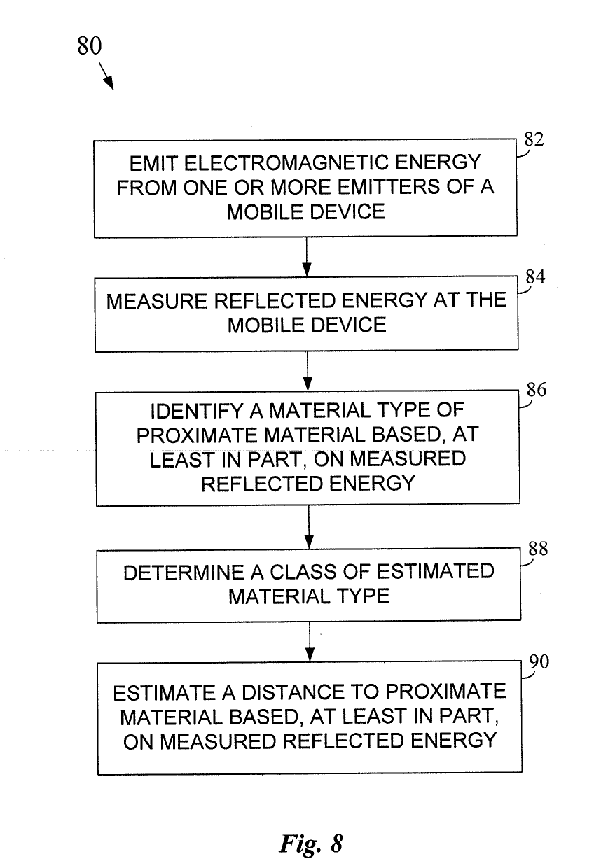

FIG. 8 is a flowchart illustrating an example method 80 for estimating a proximate material-type, a class of an estimated proximate material-type, and/or a distance to a proximate material for a mobile device in accordance with an implementation. In some implementations, for example, some or all of the method 80 may be implemented by a digital processing device (e.g., processing unit 20 of FIG. 1 or similar structures) or other machine. The emission of electromagnetic energy (e.g., a light pulse, etc.) from one or more emitters associated with a mobile device may be initiated (block 82). The electromagnetic energy may propagate toward a proximate material and be reflected thereby. The reflected energy may then be detected and measured by one or more sensors of the mobile device (block 84). A material-type of the proximate material may be estimated based, at least in part, on the measured reflected energy information (block 86). A material class of the estimated proximate material may also be identified (block 88). A distance from the mobile device to the proximate material may also be estimated based, at least in part, on measured reflected energy (block 90).

The electromagnetic energy emitted from the one or more emitters may be light (e.g., IR light, visible light, ultra-violet light, laser light, etc.) or non-light. In some implementations, a single pulse of electromagnetic energy having a specific spectral profile may be emitted from a single emitter of a mobile device. In other implementations, multiple pulses having different spectral profiles may be emitted from multiple emitters or from a single emitter having multiple transmit filters. In various implementations, the one or more sensors of the mobile device may include, for example, multiple sensors having different frequency responses, multiple sensors having multiple corresponding filters where each sensor/filter combination has a different frequency response, or a single sensor having multiple corresponding filters, where each sensor/filter combination has a different frequency response. In at least one approach, where multiple pulses having different spectral profiles are emitted by a mobile device, a single sensor or single sensor/filter combination having a fixed frequency response may be used.

To identify a material-type of a proximate material using reflected energy information, the reflected energy information may, in some implementations, be normalized. The normalization of the reflected energy information may, in some implementations, be performed by dividing energy readings of various sensors involved in the measurement by the energy reading of a particular sensor (e.g., sensor A 16 in FIG. 1). Other normalization techniques may alternatively be used. The normalized reflected energy measurements may then be compared to normalized test data for a large number of different material-types. By normalizing the information, dependence of the information on distance to the reflecting surface from the mobile device may be significantly reduced or eliminated. Normalized test data may be stored within the mobile device in some implementations. In other implementations, non-normalized test data may be stored within a mobile device and the non-normalized test data may be normalized at the time of the comparison or at some other time. In still other implementations, both normalized and non-normalized test data may be stored within a device. Test data may, in some implementations, be stored in a location other than the mobile device (e.g., on a remote server, etc.). A criterion may be used to identify a material-type from, for example, a database or lookup table that the normalized reflected energy information most closely matches. In one approach, for example, a nearest neighbor rule may be used as a criterion. Other criteria may alternatively be used.

To classify a proximate material, a lookup table approach may be used in some implementations. That is, the identified material-type may be entered into a lookup table and a corresponding material class may be returned. The lookup table may be stored within the mobile device or at another location (e.g., a network server, etc.).

In at least one implementation, the distance may be estimated by comparing the non-normalized reflected energy measurements to the non-normalized test data for the estimated material-type. A criterion may be used (e.g., nearest neighbor search, etc.) to determine the distance at which the measured reflected energy information most closely matches the test information for the estimated material-type. It should be appreciated that other techniques for determining the material-type, the material class, and/or the distance of the proximate material may be used in other implementations.

Once an estimated material-type, material class, and/or distance have been determined, this information may be used to perform one or more context awareness applications for the mobile device. Some context awareness applications may include, for example: (1) determining device position (e.g., in bag, in pocket, on tabletop, etc.) and using this information to: (a) estimate device access time (for use, e.g., in determining a number of rings until forwarding to voicemail), (b) estimate latency in user response to text messages and email, (c) efficiently control resource management for application (e.g., disable screen if device in purse/pocket, put in sleep mode if device in bag, etc.), (d) improve performance of a motion classifier, (e) adjust ringtone volume, and/or others; (2) determining if user is near device (by detection of proximate skin); (3) determining skin type of user; (4) detecting anomalies (e.g., collecting material type and/or range data over time while periodically testing for shifts in the distribution which may be an indicator that a different user is now varying the device); and/or other applications.

The terms, “and”, “or”, and “and/or” as used herein may include a variety of meanings that also are expected to depend at least in part upon the context in which such terms are used. Typically, “or” if used to associate a list, such as A, B or C, is intended to mean A, B, and C, here used in the inclusive sense, as well as A, B or C, here used in the exclusive sense. In addition, the term “one or more” as used herein may be used to describe any feature, structure, or characteristic in the singular or may be used to describe a plurality or some other combination of features, structures or characteristics. Though, it should be noted that this is merely an illustrative example and claimed subject matter is not limited to this example.

The methodologies described herein can be implemented by various means depending upon the application. For example, these methodologies can be implemented in hardware, firmware, software, or a combination thereof. For hardware implementations, processing may be implemented within, for example, one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, electronic devices, other electronic units designed to perform the functions described herein, or a combination thereof. Herein, the term “control logic” encompasses logic implemented by software, hardware, firmware, or a combination.

For a firmware and/or software implementation, methodologies can be implemented with modules (e.g., procedures, functions, and so on) that perform functions described herein. Any machine readable digital medium tangibly embodying instructions can be used in implementing methodologies described herein. For example, software codes can be stored in a storage medium and executed by a processing unit. Storage can be implemented within a processing unit or external to a processing unit. As used herein, the terms “storage medium,” “storage media,” “storage device,” “digital storage,” or the like refer to any type of long term, short term, volatile, nonvolatile, or other storage structures and are not to be limited to any particular type of memory or number of memories, or type of media upon which data is stored.

If implemented in firmware and/or software, the functions may be stored as one or more instructions or code on a computer readable medium. Examples include computer readable media encoded with a data structure and computer readable media encoded with a computer program. Computer-readable media may take the form of an article of manufacture. Computer-readable media includes physical computer storage media. A computer readable storage medium may be any available digital medium that can be accessed by a computing system. By way of example, and not limitation, such computer-readable media can comprise RAM, ROM, EEPROM, CD-ROM or other optical disk storage, magnetic disk storage or other magnetic storage devices, or any other medium that can be used to store desired program code in the form of instructions or data structures and that can be accessed by a computer; disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media.

Techniques described herein may be implemented in conjunction with various wireless communication networks such as, for example, a wireless wide area network (WWAN), a wireless local area network (WLAN), a wireless personal area network (WPAN), and so on. The terms “network” and “system” may be used interchangeably. The terms “position” and “location” may be used interchangeably. A WWAN may be a Code Division Multiple Access (CDMA) network, a Time Division Multiple Access (TDMA) network, a Frequency Division Multiple Access (FDMA) network, an Orthogonal Frequency Division Multiple Access (OFDMA) network, a Single-Carrier Frequency Division Multiple Access (SC-FDMA) network, a Long Term Evolution (LTE) network, a WiMAX (IEEE 802.16) network, and so on. A CDMA network may implement one or more radio access technologies (RATs) such as, for example, cdma2000, Wideband-CDMA (W-CDMA), and so on. Cdma2000 may include IS-95, IS-2000, and IS-856 standards. A TDMA network may implement Global System for Mobile Communications (GSM), Digital Advanced Mobile Phone System (D-AMPS), or some other RAT. GSM and W-CDMA are described in documents from a consortium named “3rd Generation Partnership Project” (3GPP). Cdma 2000 is described in documents from a consortium named “3rd Generation Partnership Project 2” (3GPP2). 3GPP and 3GPP2 documents are publicly available. A WLAN may be, for example, an IEEE 802.11x network or some other type of network. A WPAN may be, for example, a Bluetooth network, an IEEE 802.15x network, or some other type of network. Techniques disclosed herein may also be implemented in conjunction with any combination of WWAN, WLAN, and/or WPAN.

As used herein, the term “mobile device” refers to a device such as a cellular telephone, smart phone, or other wireless communication device; a personal communication system (PCS) device; a personal navigation device (PND); a Personal Information Manager (PIM); a Personal Digital Assistant (PDA); a laptop computer; a tablet computer; a portable media player; or other suitable mobile or portable device which is capable of receiving wireless communication and/or navigation signals. The term “mobile device” is also intended to include devices which communicate with a personal navigation device (PND), such as by short-range wireless, infra-red, wireline connection, or other connection—regardless of whether satellite signal reception, assistance data reception, and/or position-related processing occurs at the device or at the PND. Also, the term “mobile device” is intended to include all devices, including wireless communication devices, computers, laptops, etc. which are capable of communication with a server, such as via the Internet, Wi-Fi, or other network, and regardless of whether satellite signal reception, assistance data reception, and/or position-related processing occurs at the device, at a server, or at another device associated with the network. Any operable combination of the above are also considered a “mobile device.”

Designation that something is “optimized,” “required,” or other similar designation does not indicate that the current disclosure applies only to systems that are optimized, or systems in which the “required” elements are present (or other limitation due to other designations). These designations refer only to the particular described implementation. Of course, many implementations are possible. The techniques can be used with protocols other than those discussed herein, including protocols that are in development or to be developed.

In the preceding detailed description, numerous specific details have been set forth to provide a thorough understanding of claimed subject matter. However, it will be understood by those skilled in the art that claimed subject matter may be practiced without these specific details. In other instances, methods or structures that would be known by one of ordinary skill have not been described in detail so as not to obscure claimed subject matter.

Some portions of the preceding detailed description have been presented in terms of logic, algorithms, or symbolic representations of operations on binary states stored within a storage medium of a specific apparatus or special purpose computing device or platform. In the context of this particular specification, the term specific apparatus or the like may include a general purpose computer once it is programmed to perform particular functions pursuant to instructions from program software. Algorithmic descriptions or symbolic representations are examples of techniques used by those of ordinary skill in the signal processing or related arts to convey the substance of their work to others skilled in the art. An algorithm is here, and generally, considered to be a self-consistent sequence of operations or similar signal processing leading to a desired result. In this context, operations or processing involve physical manipulation of physical quantities. Typically, although not necessarily, such quantities may take the form of electrical or magnetic signals capable of being stored, transferred, combined, compared or otherwise manipulated as electronic signals representing information. It has proven convenient at times, principally for reasons of common usage, to refer to such signals as bits, data, values, elements, symbols, characters, terms, numbers, numerals, information, or the like. It should be understood, however, that all of these or similar terms are to be associated with appropriate physical quantities and are merely convenient labels.

Unless specifically stated otherwise, as apparent from the following discussion, it is appreciated that throughout this specification discussions utilizing terms such as “processing,” “computing,” “calculating,” “determining,” “establishing,” “obtaining,” “identifying,” “selecting,” “generating,” “estimating,” “initializing,” or the like may refer to actions or processes of a specific apparatus, such as a special purpose computer or a similar special purpose electronic computing device. In the context of this specification, therefore, a special purpose computer or a similar special purpose electronic computing device is capable of manipulating or transforming signals, typically represented as physical electronic or magnetic quantities within memories, registers, or other information storage devices, transmission devices, or display devices of the special purpose computer or similar special purpose electronic computing device. In the context of this particular patent application, the term “specific apparatus” may include a general purpose computer once it is programmed to perform particular functions pursuant to instructions from program software.

A computer-readable storage medium typically may be non-transitory or comprise a non-transitory device. In this context, a non-transitory storage medium may include a device that is tangible, meaning that the device has a concrete physical form, although the device may change its physical state. Thus, for example, non-transitory refers to a device remaining tangible despite this change in state.

While there has been illustrated and described what are presently considered to be example features, it will be understood by those skilled in the art that various other modifications may be made, and equivalents may be substituted, without departing from claimed subject matter. Additionally, many modifications may be made to adapt a particular situation to the teachings of claimed subject matter without departing from the central concept described herein.

Therefore, it is intended that claimed subject matter not be limited to particular disclosed examples, but that such claimed subject matter may also include all aspects falling within the scope of appended claims, and equivalents thereof.

What is claimed is:

1. A machine implemented method comprising:
emitting electromagnetic energy from one or more emitters of a mobile device; and
estimating a range from said mobile device to a proximate surface based, at least in part, on spectral properties of reflected energy received by one or more sensors of said mobile device, said reflected energy including electromagnetic energy that was emitted from said one or more emitters and reflected from said proximate surface.

2. The machine implemented method of claim 1, wherein:
said electromagnetic energy comprises light and said one or more sensors comprise at least one light sensor.

3. The machine implemented method of claim 1, wherein:
said electromagnetic energy includes infra-red (IR) light and said one or more sensors comprise at least one IR light sensor.

4. The machine implemented method of claim 1, further comprising:
determining a material-type of said proximate surface based, at least in part, on said spectral properties of said reflected energy.

5. The machine implemented method of claim 4, wherein:
determining said material-type of said proximate surface comprises comparing normalized reflected energy measurements to stored test information for a plurality of different materials.

6. The machine implemented method of claim 4, wherein:
said estimating said range comprises estimating said range based, at least in part, on said material-type of said proximate surface.

7. The machine implemented method of claim 4, wherein:
said estimating said range includes comparing non-normalized reflected energy measurements to stored test information for said material-type.

8. The machine implemented method of claim 4, further comprising:
determining a material class for said proximate surface based, at least in part, on said material-type of said proximate surface.

9. A machine implemented method comprising:
emitting electromagnetic energy from one or more emitters of a mobile device;
measuring one or more spectral properties of reflected energy at said mobile device, said reflected energy including energy that was emitted by said one or more emitters, reflected from a surface proximate to said mobile device, and received by one or more sensors of said mobile device; and
identifying a material-type of said surface proximate to said mobile device based, at least in part, on said spectral properties.

10. The machine implemented method of claim 9, wherein:
said measuring one or more spectral properties of reflected energy at said mobile device includes measuring received energy levels in different spectral regions to generate measured energy levels; and
identifying said material-type of said surface proximate to said mobile device includes:
normalizing said measured energy levels to generate normalized energy levels; and
comparing said normalized energy levels to normalized test data for a plurality of different material-types.

11. The machine implemented method of claim 10, wherein:
comparing said normalized energy levels to said normalized test data for said plurality of different material-types comprises using a nearest neighbor search.

12. The machine implemented method of claim 9, further comprising:
determining a distance between said mobile device and said surface based, at least in part, on said material-type.

13. The machine implemented method of claim 12, wherein:
said measuring one or more spectral properties of reflected energy at said mobile device includes measuring received energy levels in different spectral regions to generate measured energy levels; and
determining said distance between said mobile device and said surface includes comparing said measured energy levels to non-normalized test data for said material-type of said surface, said non-normalized test data for said material-type of said surface including data for multiple different distances.

14. The machine implemented method of claim 13, wherein:
comparing said measured energy levels to test data for said material-type of said surface comprises using a nearest neighbor search.

15. The machine implemented method of claim 9, wherein:
emitting electromagnetic energy includes emitting light and said one or more sensors of said mobile device comprise at least one light sensor.

16. The machine implemented method of claim 9, wherein:
emitting electromagnetic energy includes emitting infra-red (IR) light and said one or more sensors of said mobile device includes at least one IR light sensor.

17. A mobile device comprising:
one or more electromagnetic energy emitters;
one or more electromagnetic energy sensors; and
a material-type estimator to identify a material-type of a surface proximate to said mobile device based, at least in part, on spectral properties of reflected energy, said reflected energy comprising electromagnetic energy that was emitted by said one or more electromagnetic energy emitters, reflected from said surface, and sensed by said one or more electromagnetic energy sensors.

18. The mobile device of claim 17, wherein:
said spectral properties of said reflected energy comprise energy levels of said reflected energy in different spectral regions; and
said material-type estimator comprises a comparison unit to compare normalized versions of said energy levels of said reflected energy to normalized test data for a plurality of possible material-types.

19. The mobile device of claim 17, further comprising:
a range estimator to estimate a distance between said mobile device and said surface based, at least in part, on said material-type.

20. The mobile device of claim 19, wherein:
said spectral properties of said reflected energy comprise energy levels of said reflected energy in different spectral regions; and
said range estimator comprises a comparison unit to compare said energy levels of said reflected energy to test data for said material-type of said surface, said test data for said material-type of said surface including data for multiple different distances.

21. A mobile device comprising:
one or more electromagnetic energy emitters;
one or more electromagnetic energy sensors; and
a range estimator to estimate a distance between said mobile device and a proximate surface based, at least in part, on spectral properties of reflected energy received at said one or more electromagnetic energy sensors, said reflected energy including energy that was emitted by said one or more electromagnetic energy emitters and reflected by said proximate surface.

22. The mobile device of claim 21, further comprising:
a material-type estimator to identify a material-type of said proximate surface based, at least in part, on said spectral properties of said reflected energy received at said one or more electromagnetic energy sensors.

23. The mobile device of claim 22, wherein:
said range estimator to estimate said distance based, at least in part, on said material-type of said proximate surface.

24. An apparatus comprising: a digital storage medium having instructions stored thereon executable by a computing system to:
initiate emission of light from one or more emitters of a mobile device;
measure one or more spectral properties of reflected light received at one or more sensors of said mobile device to generate measured properties, said reflected light including light that was emitted from said one or more emitters and reflected from a surface proximate to said mobile device; and
identify a material-type of said surface based, at least in part, on said measured properties.

25. The apparatus of claim 24, wherein said instructions are further executable to:
determine a distance between said mobile device and said surface based, at least in part, on said material-type.

26. The apparatus of claim 25, wherein:
said instructions executable to measure said one or more spectral properties of reflected light comprise instructions executable to measure energy levels of said reflected light in different spectral regions; and
said instructions executable to determine said distance between said mobile device and said surface comprises instructions executable to compare said energy levels of said reflected light to test data for said material-type of said surface, said test data for said material-type of said surface including data for multiple different distances.

27. The apparatus of claim 26, wherein:
said instructions executable to identify said material-type of said surface proximate to said mobile device comprise instructions executable to:
normalize said energy levels of reflected light to generate normalized energy levels; and
compare said normalized energy levels to a normalized version of said test data for a plurality of different material-types.

28. An apparatus comprising: a digital storage medium having instructions stored thereon executable by a computing system to:
initiate emission of light from one or more emitters of a mobile device; and
estimate a range from said mobile device to a proximate surface based, at least in part, on spectral properties of reflected light received at said mobile device, said reflected light including light that was emitted by said one or more emitters and reflected from said proximate surface.

29. The apparatus of claim 28, wherein said instructions are further executable to:
determine a material-type of said proximate surface based, at least in part, on said spectral properties of said reflected light.

30. The apparatus of claim 29, wherein:
said instructions executable to determine said material-type of said proximate surface comprises instructions executable to compare normalized reflected energy measurements for different spectral regions to a database of test information for a plurality of different materials.

31. The apparatus of claim 29, wherein:
said instructions executable to estimate said range comprises instructions executable to estimate said range based, at least in part, on said material-type of said proximate surface.

32. The apparatus of claim 31, wherein:
said instructions executable to estimate said range comprises instructions executable to compare non-normalized reflected energy measurements to test information for said material-type of said proximate surface.

33. An apparatus comprising:
means for emitting electromagnetic energy from a mobile device; and
means for estimating a range from said mobile device to a proximate surface based, at least in part, on spectral properties of reflected energy received by one or more sensors of said mobile device, said reflected energy including electromagnetic energy that was emitted by said means for emitting electromagnetic energy and reflected from said proximate surface.

34. The apparatus of claim 33, wherein:
said means for emitting electromagnetic energy comprises means for emitting light.

35. The apparatus of claim 33, wherein:
said means for emitting electromagnetic energy comprises means for emitting infra-red (IR) light.

36. The apparatus of claim 33, further comprising:
means for determining a material-type of said proximate surface based, at least in part, on said spectral properties of said reflected energy.

37. The apparatus of claim 36, wherein:
said means for determining said material-type of said proximate surface comprises means for comparing normalized reflected energy measurements to stored test information for a plurality of different materials.

38. The apparatus of claim 36, wherein:
said means for estimating said range comprises means for estimating said range based, at least in part, on said material-type of said proximate surface.

39. The apparatus of claim 36, wherein:
said means for estimating said range comprises means for comparing non-normalized reflected energy measurements to stored test information for said material-type.

40. The apparatus of claim 36, further comprising:
means for determining a material class for said proximate surface based, at least in part, on said material-type of said proximate surface.

41. An apparatus comprising:
means for emitting electromagnetic energy from a mobile device;
means for measuring one or more spectral properties of reflected energy at said mobile device, said reflected energy including energy that was emitted by said means for emitting electromagnetic energy, reflected from a surface proximate to said mobile device, and received by one or more sensors of said mobile device; and
means for identifying a material-type of said surface proximate to said mobile device based, at least in part, on said spectral properties.

42. The apparatus of claim 41, wherein:
said means for measuring one or more spectral properties of reflected energy at said mobile device comprises means for measuring received energy levels in different spectral regions to generate measured energy levels; and
said means for identifying said material-type of said surface proximate to said mobile device comprises:
means for normalizing said measured energy levels to generate normalized energy levels; and
means for comparing said normalized energy levels to normalized test data for a plurality of different material-types.

43. The apparatus of claim 42, wherein:
said means for comparing said normalized energy levels to said normalized test data for said plurality of different material-types comprises means for performing a nearest neighbor search.

44. The apparatus of claim 41, further comprising:
means for determining a distance between said mobile device and said surface based, at least in part, on said material-type.

45. The apparatus of claim 44, wherein:
said means for measuring one or more spectral properties of reflected energy at said mobile device comprises means for measuring received energy levels in different spectral regions to generate measured energy levels; and
said means for determining said distance between said mobile device and said surface comprises means for comparing said measured energy levels to non-normalized test data for said material-type of said surface, said non-normalized test data for said material-type of said surface including data for multiple different distances.

46. The apparatus of claim 45, wherein:
said means for comparing said measured energy levels to said non-normalized test data for said material-type of said surface comprises means for performing a nearest neighbor search.

47. The apparatus of claim 41, wherein:
said means for emitting electromagnetic energy comprises means for emitting light.

48. The apparatus of claim 41, wherein:
said means for emitting electromagnetic energy comprises means for emitting infra-red (IR) light.
